(19) United States
(12) Patent Application Publication
(10) Pub. No.: US 2015/0035839 A1
(43) Pub. Date: Feb. 5, 2015

(54) SYSTEM AND METHOD FOR PROVIDING POSITIVE AND NEGATIVE VOLTAGES WITH A SINGLE INDUCTOR

(71) Applicant: QUALCOMM Mems Technologies, Inc., San Diego, CA (US)

(72) Inventors: Didier H. Farenc, San Diego, CA (US); Paul Penchin Pan, San Diego, CA (US)

(73) Assignee: QUALCOMM Mems Technologies, Inc., San Diego, CA (US)

(21) Appl. No.: 13/957,202

(22) Filed: Aug. 1, 2013

(51) Int. Cl. H02M 3/158; G06T 1/20; G09G 5/00

(52) U.S. Cl. CPC H02M 3/1582; G09G 5/00; G06T 1/20
USPC 345/501; 323/271; 345/212

(57) ABSTRACT

This disclosure provides systems, methods and apparatus, including computer programs encoded on computer storage media, for providing positive and negative voltages using a single inductor. In one aspect, the apparatus includes a single inductor having a first end and a second end. The first end is coupled to a first switch and configured to connect to either a power source or a negative output node depending on the state of the first switch. The second end is coupled to a second switch and is configured to connect to either a ground potential or a positive output node depending on the state of the second switch. The apparatus further includes a controller adapted to configure the switches into one of a plurality of configurations at a time.

### TECHNICAL FIELD

This disclosure relates to systems and methods for driving electromechanical systems such as interferometric modulators, and in particular, to systems and methods for providing positive and negative voltages with a single inductor.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Displays based on electromechanical devices such as the interferometric modulators sometimes use a drive scheme in which a negative voltage and a positive voltage are used to drive data lines of the displays. It is desirable to design a high efficiency device for providing the positive and negative voltages. In addition, for better system integration, it is also desirable to reduce the number of external components in the device for providing the positive and negative voltages.

### SUMMARY

The systems, methods and devices of the disclosure each have several innovative aspects, no single one of which is solely responsible for the desirable attributes disclosed herein.

One innovative aspect of the subject matter described in this disclosure can be implemented in a power supply capable of providing a negative output voltage and a positive output voltage. The power supply comprises a power source; an inductor having a first end and a second end; and a controller adapted to configure the first and second switches into at least a first configuration, a second configuration, a third configuration and a fourth configuration. The first end of the inductor is coupled to at least a first switch and is configured to connect to either the power source or a negative output node depending on the state of the first switch. The second end of the inductor is coupled to at least a second switch and is configured to connect to either a ground potential or a positive output node depending on the state of the second switch. The negative output node is configured to generate the negative output voltage. The positive output node is configured to generate the positive output voltage.

In the first configuration, the first end of the inductor is connected to the negative output node while the second end of the inductor is connected to the positive output node, causing a current to flow from the negative output node to the positive output node through the inductor. In the second configuration, the first end of the inductor is connected to the power source while the second end of the inductor is connected to the ground potential, causing a current to flow from the power source to the ground potential through the inductor. In the third configuration the first end of the inductor is connected to the power source while the second end of the inductor is connected to the positive output node, causing a current to flow from the power source to the positive output node through the inductor. In the fourth configuration the first end of the inductor is connected to the negative output node while the second end of the inductor is connected to the ground potential, causing a current to flow from the negative output node to the ground potential through the inductor.

In various embodiments, the controller can configure the first and second switches into the first configuration when the inductor is being discharged and the voltages at the positive output node and the negative output node are substantially different from the positive output voltage and the negative output voltage respectively. In various embodiments, the negative output voltage and the positive output voltage can have approximately the same amplitude and opposite polarities. In various embodiments, the amplitude of the negative output voltage can be between about 80% and 120% of the amplitude of the positive output voltage.

Various embodiments of the power supply can include a current sensing module that is configured to determine current flowing through the inductor. Various embodiments of the power supply can include a voltage sensing module configured to monitor voltages at the positive output node and the negative output node. In various embodiments, the controller can configure the first and the second switches based on the current flowing through the inductor and the voltages at the positive output node and the negative output node.

In various embodiments, the second switch can be an inverter configured to connect the second end of the inductor to either the ground potential or the positive output node depending on a first control signal from the controller. In various embodiments, the first switch can be an inverter configured to connect the first end of the inductor to either the power source or the negative output node depending on a second control signal from the controller. In various embodiments, the second switch can be an inverter configured to connect the second end of the inductor to either the ground potential or the positive output node depending on a first control signal from the controller. In various embodiments, the first switch can be configured to connect or disconnect the power source from the first end of the inductor depending on a second control signal from the controller. In various embodiments, the power supply can further include a diode configured to allow current to flow from the negative output node to the first end of the inductor. In various embodiments, the power supply can further include a first capacitor having a first end coupled to the positive output node and a second end coupled to the ground potential. In various embodiments, the power supply can further include a second capacitor having a first end coupled to the negative output node and a second end coupled to the ground potential.

Various embodiments of a display device can include embodiments of the power supply described above. The display device can include a plurality of display elements and a driver circuit. The driver circuit can be configured to drive the display elements with a plurality of voltages including the negative output voltage and the positive output voltage from the power supply. Various embodiments of the display device can include a display, a processor that is configured to communicate with the display and a memory device that is configured to communicate with the processor. The processor can be configured to process image data. In various embodiments, the driver circuit can be configured to send at least one signal to the display. Various embodiments of the display device can include a second controller configured to send at least a portion of the image data to the driver circuit. Various embodiments of the display device can include an image source module configured to send the image data to the processor. In various embodiments, the image source module can include at least one of a receiver, transceiver, and transmitter. Various embodiments of the display device can include an input device configured to receive input data and to communicate the input data to the processor.

Another innovative aspect of the subject matter described in this disclosure can be implemented in a method of generating a negative output voltage and a positive output voltage. The method comprises a first process that includes connecting a first end of an inductor to a negative output node and a second end of the inductor to a positive output node to cause a current to flow from the negative output node to the positive output node through the inductor, wherein the negative output node is configured to generate a negative output voltage and the positive output node is configured to generate a positive output voltage. The method comprises a second process that includes connecting the first end of the inductor to a power source and the second end of the inductor to a ground potential to cause a current to flow from the power source to the ground potential through the inductor. The method comprises a third process that includes connecting the first end of the inductor to the power source and the second end of the inductor to the positive output node to cause a current to flow from the power source to the positive output node through the inductor. The method comprises a fourth process that includes connecting the first end of the inductor to the negative output node and the second end of the inductor to the ground potential to cause a current to flow from the negative output node to the ground potential through the inductor.

In various embodiments of the method, the first process including connecting a first end of an inductor to a negative output node and a second end of the inductor to a positive output node can be performed when the inductor is being discharged and the voltages at the positive output node and the negative output node are substantially different from the positive output voltage and the negative output voltage respectively. In various embodiments, the negative output voltage and the positive output voltage can have approximately the same amplitude and opposite polarities. In various embodiments, the amplitude of the negative output voltage can be between about 80% and 120% of the amplitude of the positive output voltage.

The method can further include determining current flowing through the inductor; monitoring voltages at the positive output node and the negative output node; and selecting one of the first, second, third or fourth processes discussed above to perform based on the current flowing through the inductor and the voltages at the positive output node and the negative output node.

Another innovative aspect of the subject matter described in this disclosure can be implemented in an apparatus for providing a negative output voltage and a positive output voltage. The apparatus comprises a single power source; a single inductor having a first end and a second end; a means for connecting the first end of the inductor to either the power source or a negative output node depending on a first control signal; a means for connecting the second end of the inductor to either a ground potential or a positive output node depending on a second control signal; and a means for generating the first and second control signals to configure the first end connecting means and the second end connecting means into at least a first configuration, a second configuration, a third configuration and a fourth configuration. The negative output node is configured to generate a negative output voltage. The positive output node is configured to generate a positive output voltage.

In the first configuration the first end of the inductor is connected to the negative output node while the second end of the inductor is connected to the positive output node, causing a current to flow from the negative output node to the positive output node through the inductor. In the second configuration the first end of the inductor is connected to the power source while the second end of the inductor is connected to the ground potential, causing a current to flow from the power source to the ground potential through the inductor. In the third configuration the first end of the inductor is connected to the power source while the second end of the inductor is connected to the positive output node, causing a current to flow from the power source to the positive output node through the inductor. In the fourth configuration the first end of the inductor is connected to the negative output node while the second end of the inductor is connected to the ground potential, causing a current to flow from the negative output node to the ground potential through the inductor.

In various embodiments, the apparatus of claim 21, wherein the means for connecting the second end includes an inverter configured to connect the second end of the inductor to either the ground potential or the positive output node depending on the first control signal, and the means for connecting the first end includes an inverter configured to connect the first end of the inductor to either the power source or the negative output node depending on the second control signal.

In various embodiments of the apparatus for providing a negative output voltage and a positive output voltage, the means for connecting the second end can include an inverter configured to connect the second end of the inductor to either the ground potential or the positive output node depending on the first control signal. In various embodiments of the apparatus for providing a negative output voltage and a positive output voltage, the means for connecting the first end can include a switch configured to connect or disconnect the power source from the first end of the inductor depending on the second control signal. Various embodiments the apparatus for providing a negative output voltage and a positive output voltage can include a diode configured to allow current to flow from the negative output node to the first end of the inductor. In various embodiments of the apparatus for providing a negative output voltage and a positive output voltage the means for generating control signals can include a controller. In various embodiments of the apparatus for providing a negative output voltage and a positive output voltage, the negative output voltage and the positive output voltage can have approximately the same amplitude and opposite polarities. In various embodiments of the apparatus for providing a negative output voltage and a positive output voltage, the amplitude of the negative output voltage can be between about 80% and 120% of the amplitude of the positive output voltage.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A illustrates a Buck converter for generating a positive output voltage, and FIG. 9B illustrates a negative Buck-Boost Flyback converter for generating a negative output voltage.

FIG. 10 shows an example of an apparatus for providing a negative output voltage and a positive output voltage using a single inductor.

FIG. 11 shows another example of an apparatus for providing a negative output voltage and a positive output voltage using a single external inductor.

FIGS. 12A-12D illustrate an example of operational modes of the apparatus 1000 (shown in FIG. 11).

FIG. 13 illustrates the inductor current, the VSPOS_OK signal, the VSNEG_OK signal, and the DISCHARGE/CHARGE signal of the apparatus 1000 (shown in FIG. 11) versus time in an example of operations.

FIG. 14 shows an example of a flow diagram illustrating a method 1400 for providing negative and positive output voltages using a single inductor.

FIGS. 15A and 15B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

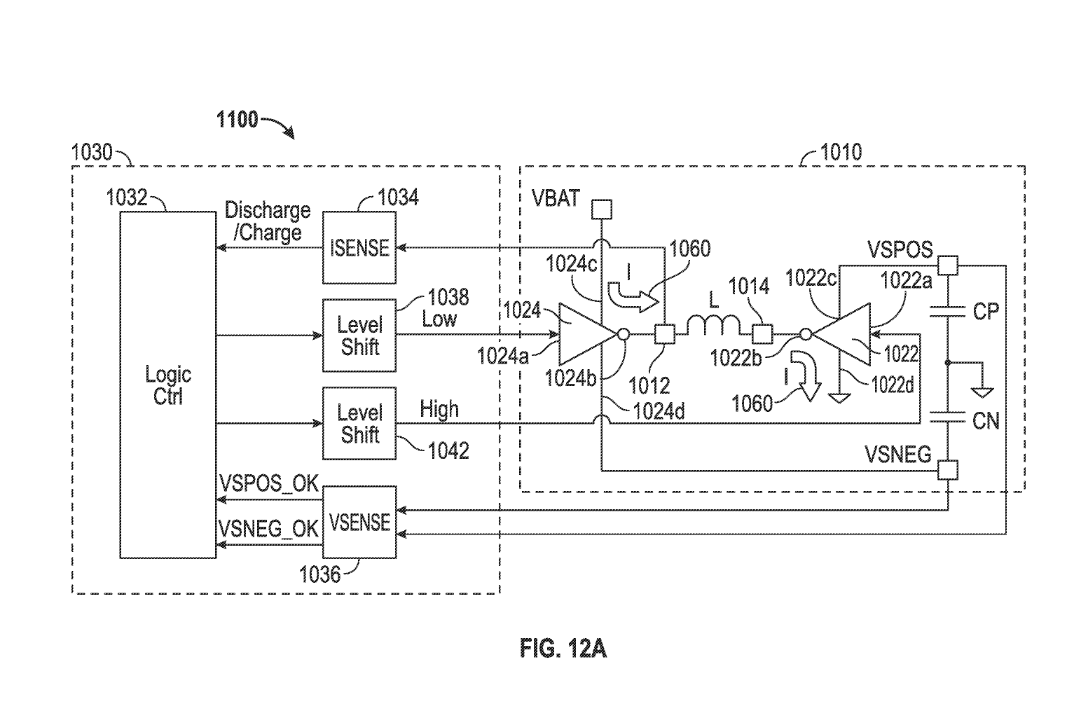

Displays such as ones based on electromechanical devices sometimes have a drive scheme in which a negative voltage and a positive voltage are used to drive a data line of the displays. One way of providing the negative and positive voltage is to have a converter (such as Buck converter 910 shown in FIG. 9A) to generate the positive voltage and a negative converter (such as Buck-Boost Flyback converter 920 shown in FIG. 9B) to generate the negative voltage. Each of the Buck converter 910 and the negative Buck-Boost Flyback converter 920 has one separate inductor and one Schottky diode. A negative Buck-Boost Flyback converter is less efficient in converting power compared to the Buck converter, because a significant portion of power efficiency is lost in the negative Buck-Boost Flyback converter due to the forward conduction voltage drop in the Schottky diode of the Buck-Boost Flyback converter. It is thus desirable to design a high efficiency device for providing the positive and negative voltages. In addition, for better system integration, it is also desirable to reduce the number of external components in the device for providing the positive and negative voltages.

Particular implementations of the subject matter described in this disclosure can be implemented to realize one or more of the following potential advantages. Certain implementations reduce the number of external components, thus allowing better system display integration. Particularly, certain implementations generate both the positive voltage and the negative voltage with only one external inductor. Also, certain implementations replace one or more of the external Schottky diode with a switch which can be integrated. In addition, certain implementations increase the overall power efficiency and reduce the discharge time as compared to the approach using two separate converters. The power efficiency is increased, partly because the inductor transfers positive charge away from the negative output to the positive output during a discharge cycle.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

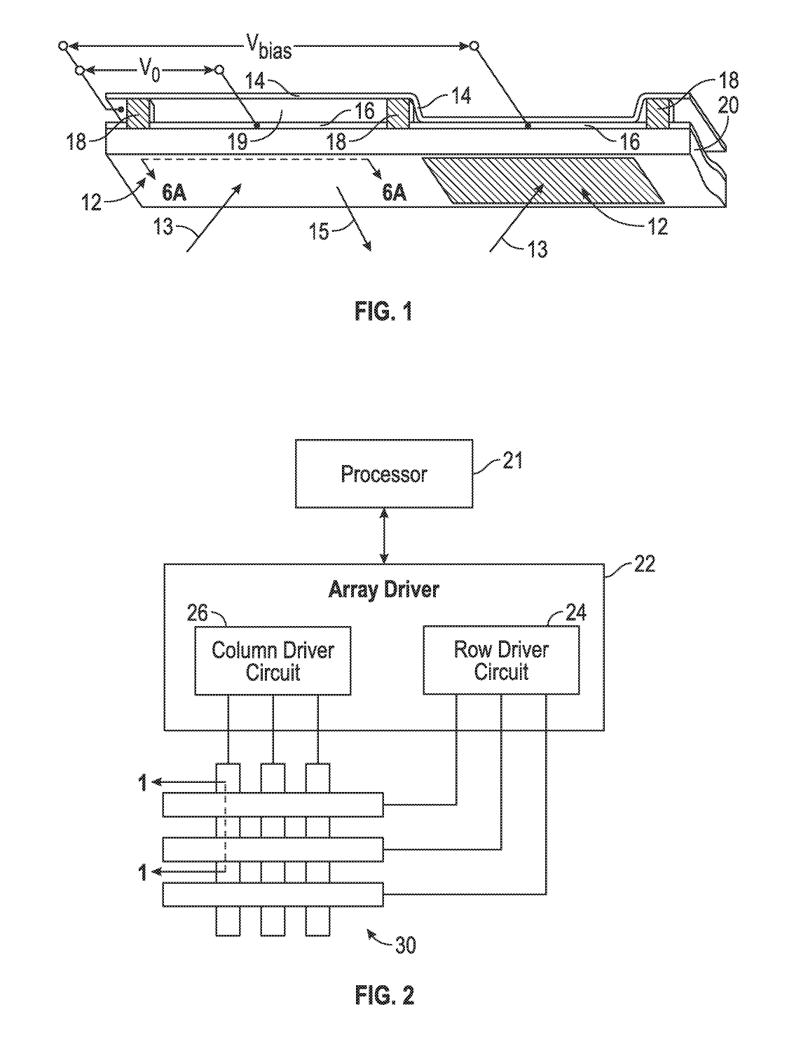

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

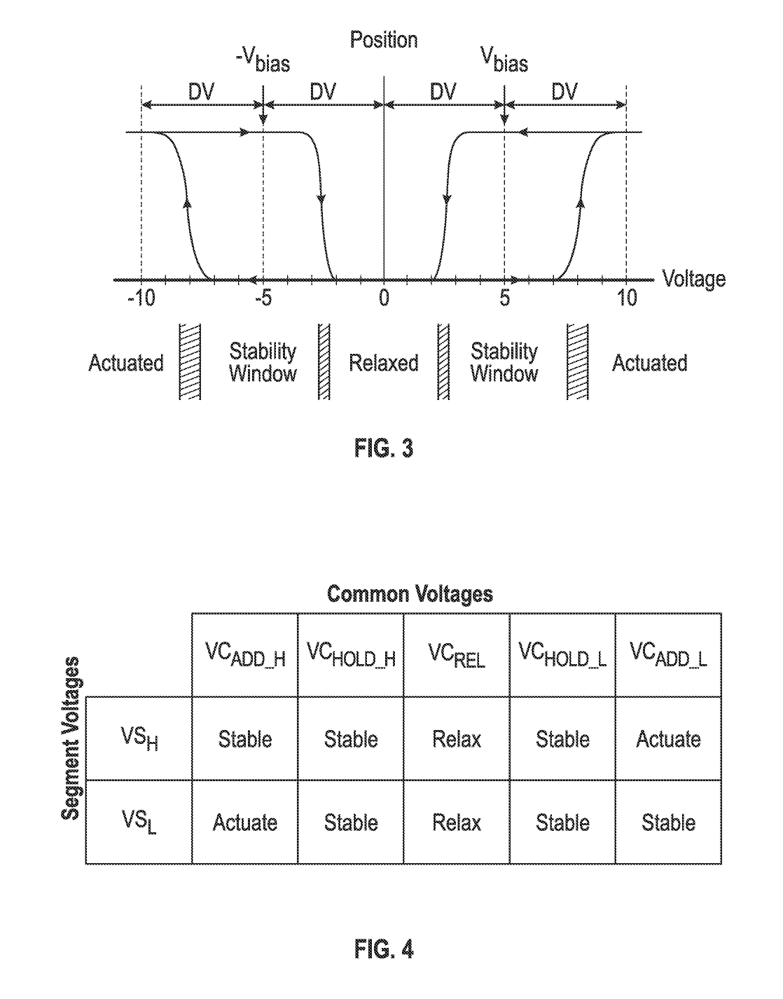

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

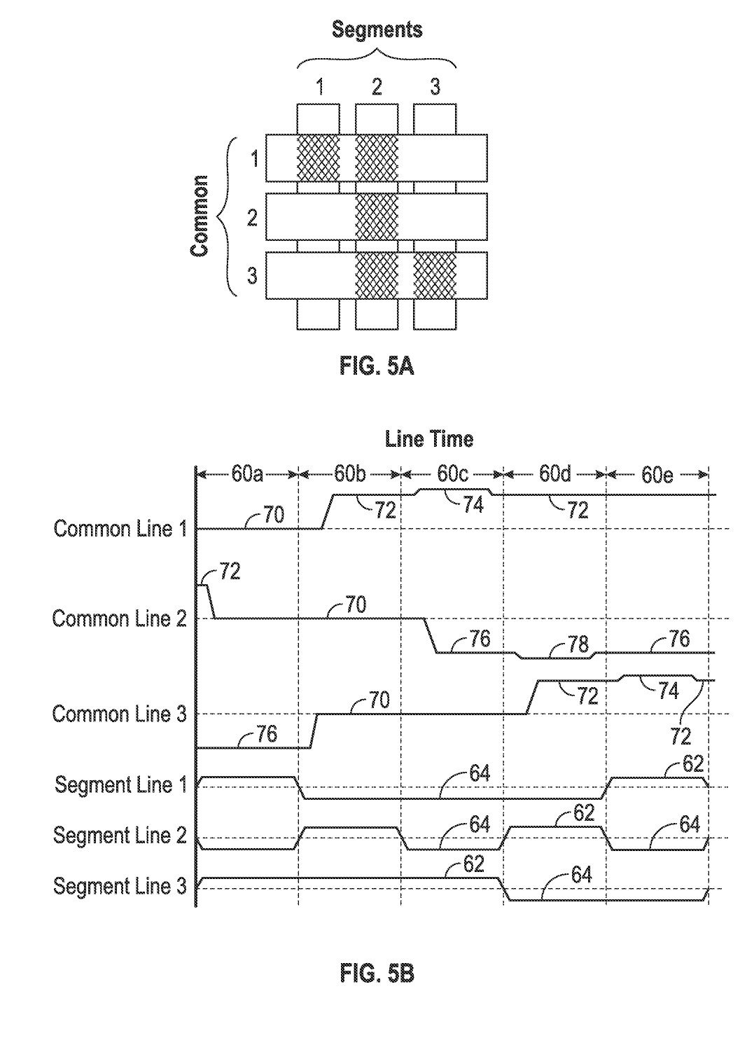

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

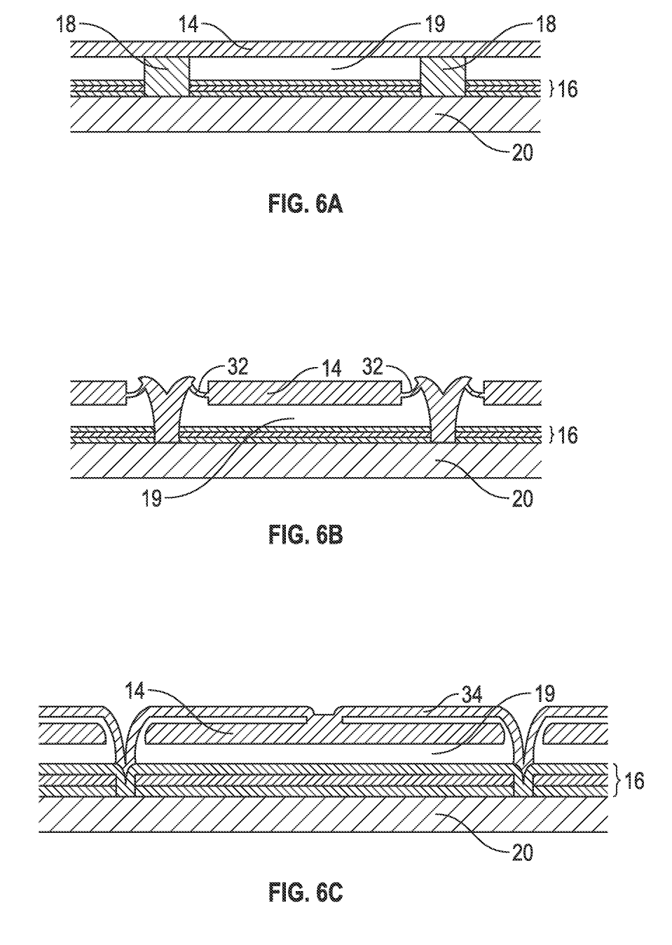

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

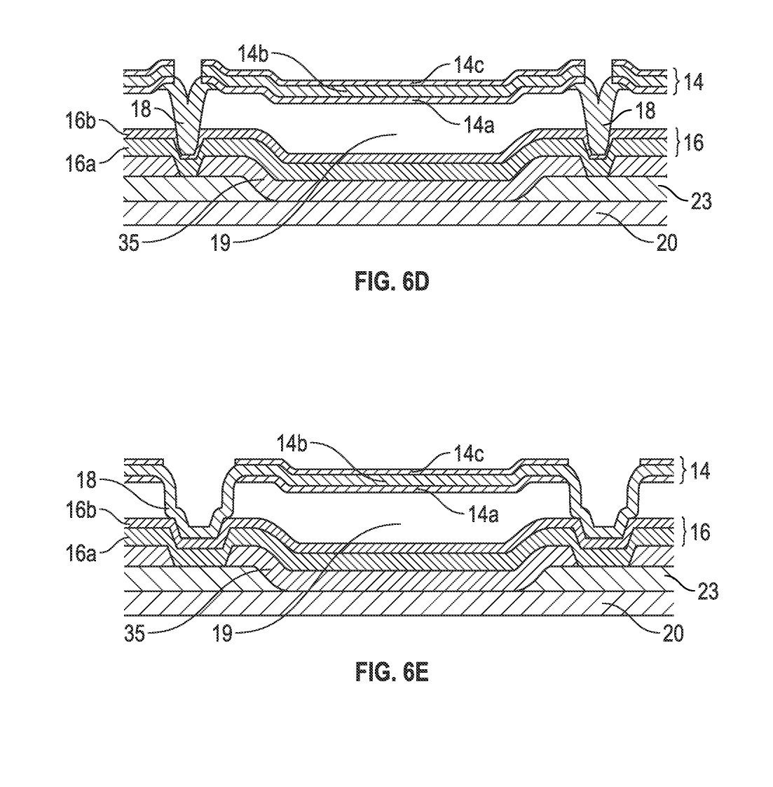

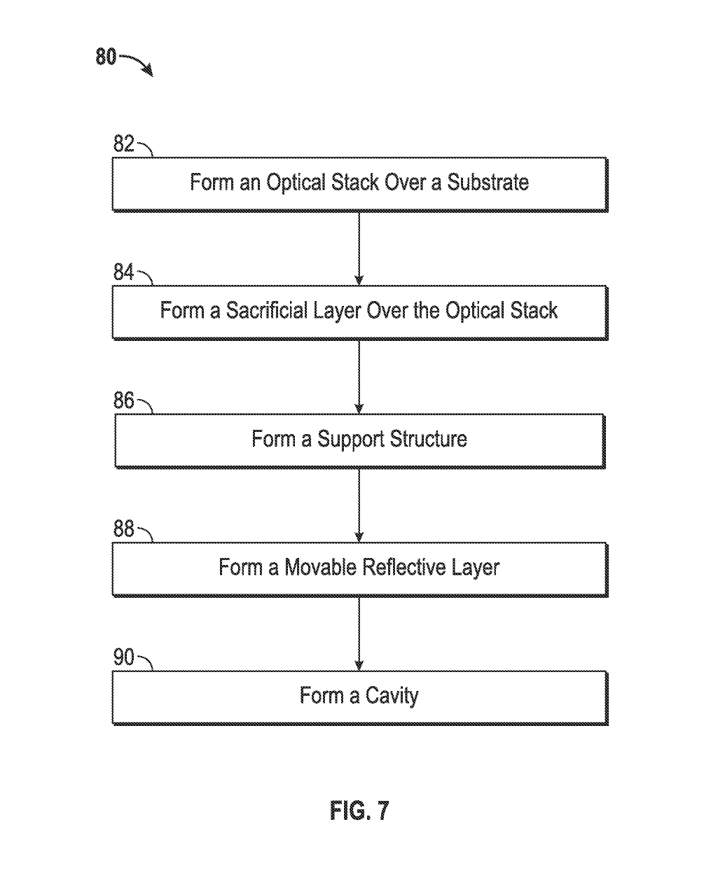

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

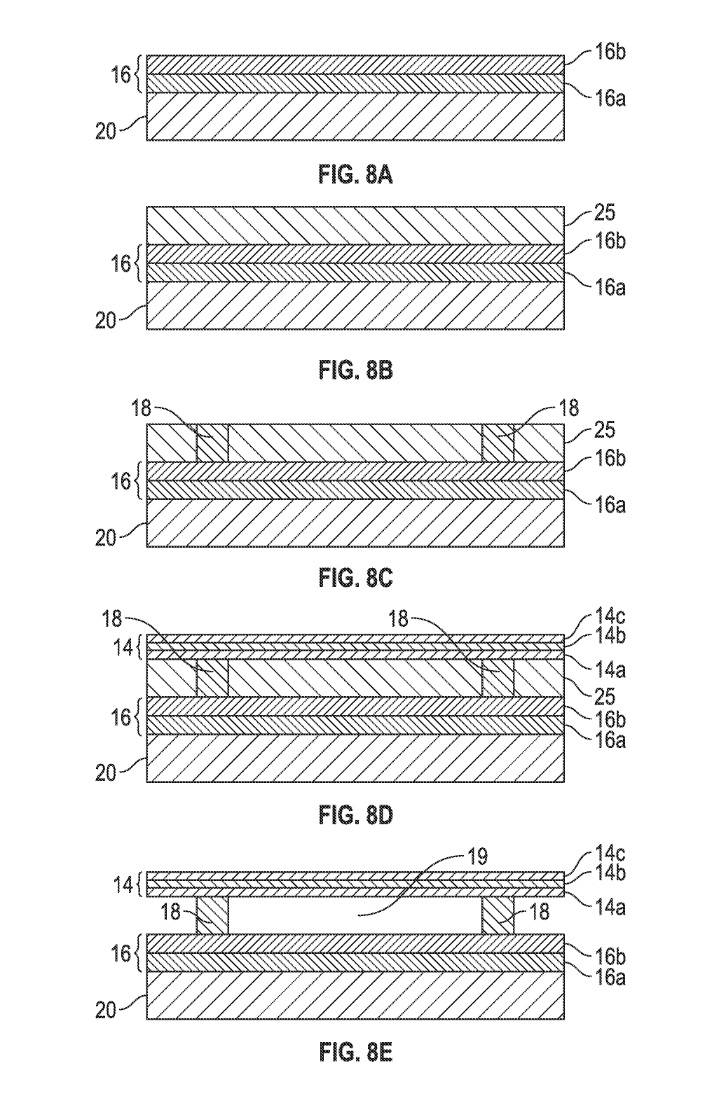

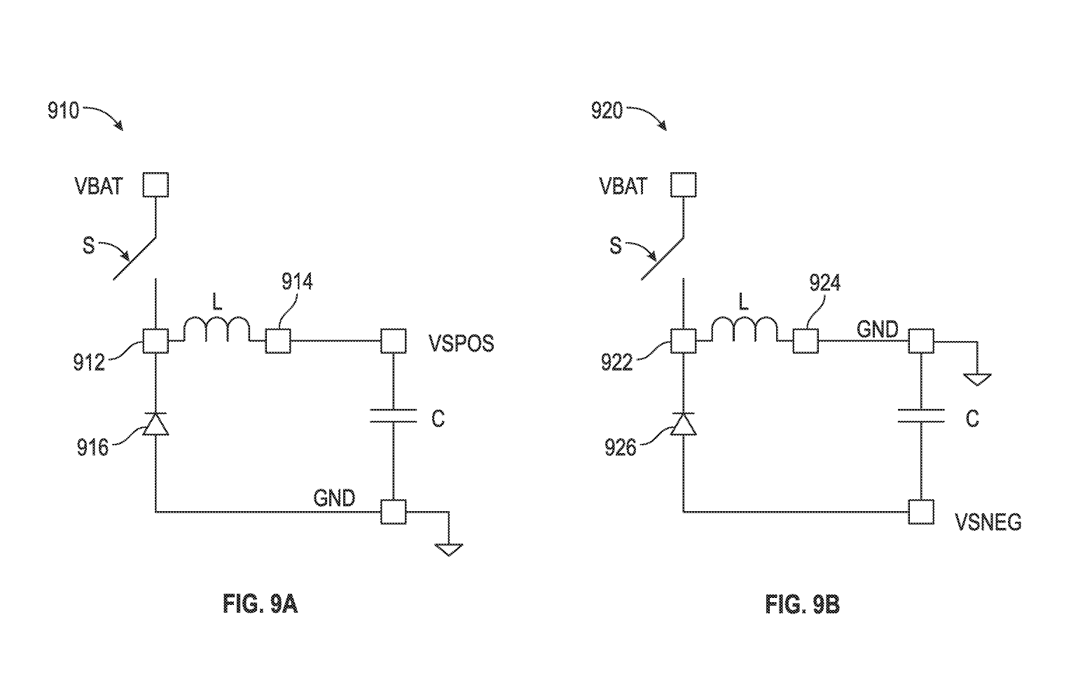

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

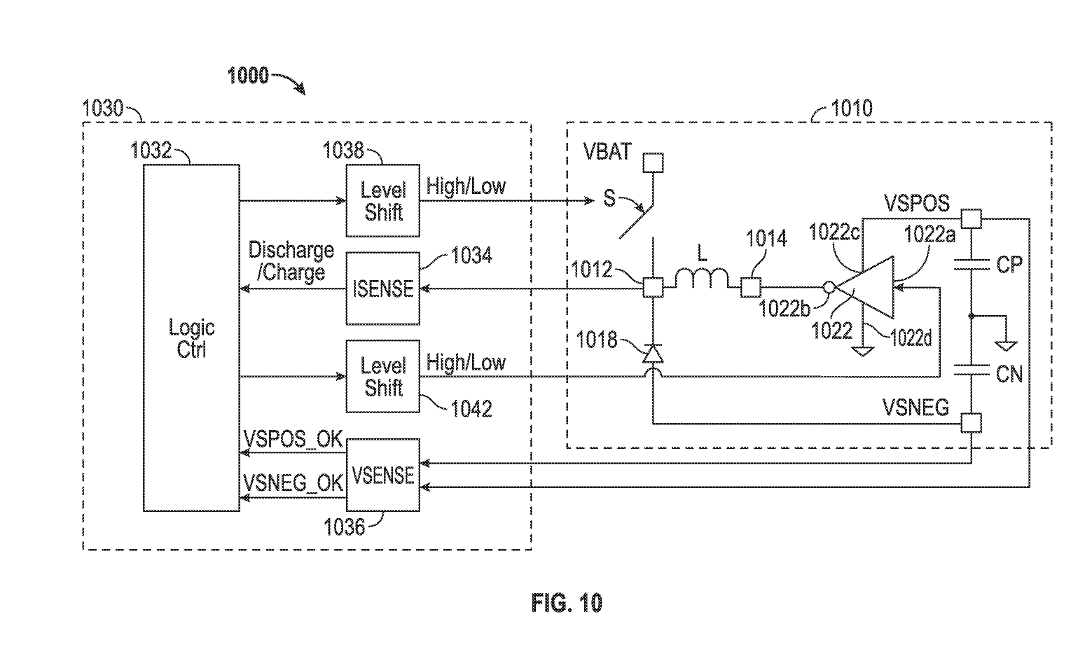

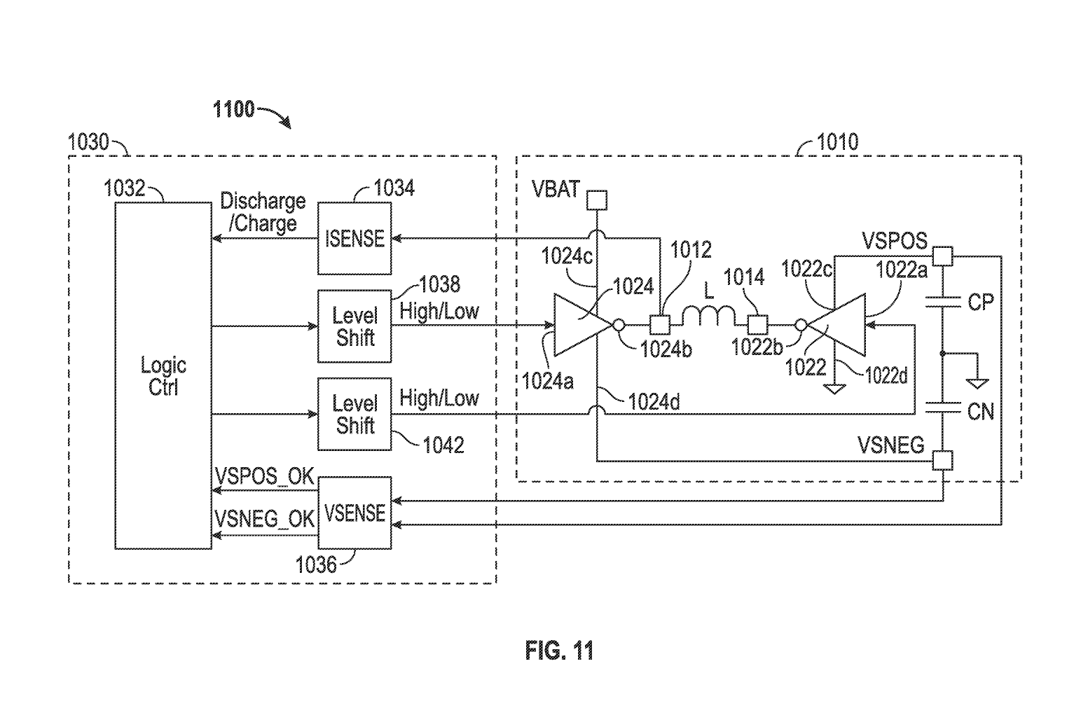

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As described above, to create a frame of an image in a display array such as one based on electromechanical devices, data signals in the form of “segment” voltages may be applied along data lines of the display, in accordance with the desired change (if any) to the state of the pixels in a given row. In one implementation, the set of segment voltages includes at least a high segment voltage VS_{H} and low segment voltage VS_{L}.

In one implementation, the high segment voltage and the low segment voltage may be a positive voltage (referred to as “positive SEG voltage”) and a negative voltage (referred to as “negative SEG voltage”). The positive SEG voltage and the negative SEG voltage values may be selected such that the average current output through the device as a result of the application of the positive SEG voltage and the negative SEG voltage is quasi-symmetric meaning that for average current output, the positive and negative SEG voltages have approximately the same amplitude. In some implementations, the average positive current output load resulting from the positive SEG voltage may have approximately an amplitude that is between about 80% and 120% of the amplitude of the average negative current output load resulting from the negative SEG voltage. In other words, in most implementations, the values of the positive SEG voltage and the negative SEG voltage are such that they support a symmetric current output load. In such implementations, asymmetric current load can cause the inductors in the circuit to discharge through the side which has the lower current output load resulting in the output current at the side having the lower current output load to become even lower. In some implementations, symmetric current output loads can be achieved when the positive SEG voltage and the negative SEG voltage have the same amplitude but different polarities. For example, the positive SEG voltage may be +1.5 volts and the negative SEG voltage may be −1.5 volts. In another example, the positive SEG voltage may be a voltage between +1.5 volts and +2 volts, and the negative SEG voltage may have an amplitude approximately the same as the positive voltage.

FIG. 9A illustrates an example of one implementation of a Buck converter 910 for generating a positive output voltage. FIG. 9B illustrates one example of an implementation of a negative Buck-Boost Flyback converter 920 for generating a negative output voltage. Referring to FIG. 9A, the Buck converter 910 receives power from a voltage source VBAT and generates the positive SEG voltage at a positive output node VSPOS. The voltage source may be any power source. In one implementation, the voltage source is a direct current power source such as a battery.

The Buck converter 910 includes an inductor L having a first end 912 and a second end 914. The first end 912 of the inductor L is connected to the voltage source VBAT via a switch S. Depending on its state, the switch S connects the first end 912 of the inductor L to, or disconnects it from, the voltage source VBAT. The switch allows current to flow through it in at least one direction in a closed state, while disallowing current from flowing through it in an open state. The switch S may include, for example, mechanical switches, FET transistors, two transistor transmission gates, or diodes. In one implementation, the switch is a p-channel metal oxide semiconductor (PMOS) transistor.

The first end 912 of the inductor L is also connected to a ground potential GND via a diode 916. The diode 916 allows current to flow in a direction from the ground potential GND to the first end 912 of the inductor L, but not in an opposite direction. In one implementation, the diode 916 may be a Schottky diode, though other types of diodes may also be used.

The second end 914 of the inductor L is connected to the positive output node VSPOS wherein the positive SEG voltage is generated. A capacitor C has a first end connected to the positive output node VSPOS and a second end connected to the ground potential GND.

Referring to FIG. 9B, the negative Flyback converter 920 receives power from a voltage source VBAT. The negative Flyback converter 920 is configured to generate the negative SEG voltage at a negative output node VSNEG. The negative Flyback converter 920 includes an inductor L having a first end 922 and a second end 924. The first end 922 of the inductor L is connected to the voltage source VBAT via a switch S.

The first end 922 of the inductor L is also connected to the negative output node VSNEG via a diode 926. The diode 926 allows current to flow in a direction from the negative output node VSNEG to the first end 922 of the inductor L, but not in an opposite direction.

The second end 924 of the inductor L is connected to the ground potential GND. A capacitor C has a first end connected to the ground potential GND and a second end connected to the negative output node VSNEG wherein the negative SEG voltage is generated.

As shown above, each of the Buck converter 910 and the negative Flyback converter 920 has one separate inductor and one diode. The negative Flyback converter 920 is less efficient in converting power compared to the Buck converter because a significant portion of power efficiency is lost in the negative Flyback converter 920 due to forward conduction voltage drop in the diode 926.

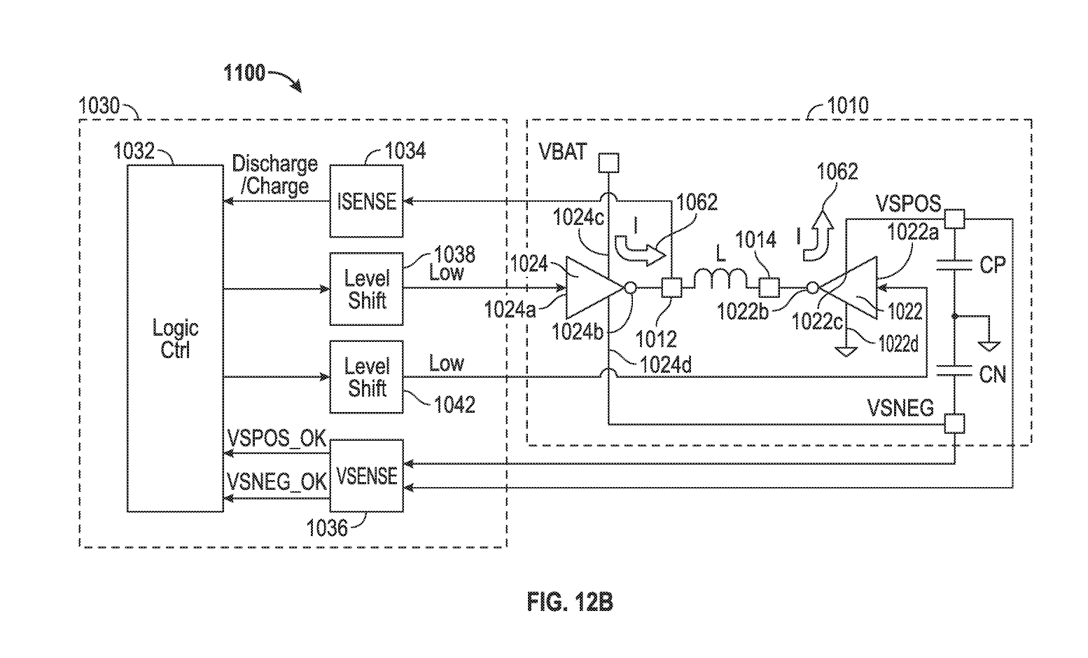

FIG. 10 shows an example of an apparatus 1000 for providing a negative output voltage and a positive output voltage using a single inductor. In one implementation, the apparatus may be integrated into a display device (shown in FIG. 2) which includes the display array 30 and the array driver 22, and provides the negative output voltage and the positive output voltage for the array driver 22 to drive the display array 30. In one implementation, the negative and positive output voltages generated by the apparatus are the negative and positive SEG voltages for the array driver 22 to apply to data lines of the display array 30.

The apparatus 1000 includes a power supply circuit 1010 and a control module 1030 coupled to the power supply circuit 1010 and configured to control the operation of the power supply circuit 1010. The power supply circuit 1010 receives power from a voltage source VBAT and generates a positive SEG voltage at a positive output node VSPOS and a negative SEG voltage at a negative output node VSNEG.

The power supply circuit 1010 includes a single inductor L having a first end 1012 and a second end 1014. The first end 1012 of the inductor L is connected to the voltage source VBAT via a switch S. Depending on a control signal from the control module 1030, the switch S connects the first end 1012 of the inductor L to, or disconnects it from, the voltage source VBAT. In one implementation, the control signal takes either a logic 1 or HIGH value or a logic 0 or LOW value.

The first end 1012 of the inductor L is also connected to the negative output node VSNEG via a diode 1018. The diode 1018 allows current to flow in a direction from the negative output node VSNEG to the first end 1012 of the inductor L, but not in an opposite direction. In one implementation, the diode 1018 may be a Schottky diode, though other types of diodes may also be used.

The second end 1014 of the inductor L is connected via an inverter 1022 to either a ground potential GND or the positive output node VSPOS. The inverter 1022 has a first terminal 1022c connected to the positive output node VSPOS and a second terminal 1022d connected to the ground potential GND. The inverter 1022 further includes an input terminal 1022a which receives a control signal from the control module 1030 and an output terminal 1022b connected to the second end 1014 of the inductor L. The output terminal 1022b is connected to the second terminal 1022d, if the control signal at the input terminal 1022a has a logic 1 or HIGH value. The output terminal 1022b is connected to the first terminal 1022c, if the control signal at the input terminal 1022a has a logic 0 or LOW value. In one implementation, the inverter 1022 is a switch that may be integrated into a circuit. The inverter 1022 may be, for example, a complementary metal oxide semiconductor (CMOS) inverter. The inverter 1022 may be a NOR gate.

The power supply circuit 1010 also includes a capacitor CP having a first end connected to the positive output node VSPOS and a second end connected to the ground potential GND, and a capacitor CN having a first end connected to the ground potential GND and a second end connected to the negative output node VSNEG.

The control module 1030 controls the operation of the power supply circuit 1010. The power supply circuit 1010 may be in a charge time and a discharge time. During a charge time, energy is transferred from the voltage source VBAT and stored in the inductor L. During a discharge time, the inductor L is discharged. Energy stored in the inductor L is transferred to at least one of the negative and positive output nodes.

The control module 1030 may include a current sensing module 1034 (e.g., a circuit) configured to sense current flowing through the inductor L and decide whether the power supply circuit 1010 should be in a charge time or a discharge time based on the sensed current in the inductor L. In one implementation, the current sensing module 1034 decides to switch from a discharge time to a charge time when the sensed current is lower than a bottom threshold (e.g., a value substantially close to zero), and to switch from a charge time to a discharge time when the sensed current is higher than a peak threshold.

The control module 1030 may also include a voltage sensing module 1036 (e.g., a circuit) configured to monitor the voltage at the positive output node VSPOS and the negative output node VSNEG and determine whether the voltages meet the design specification. In one implementation, the voltage at the positive output node VSPOS does not meet the design specification if it is substantially different from the positive SEG voltage, and the voltage at the negative output node VSNEG does not meet the design specification if it is substantially different from the negative SEG voltage. In one implementation, the voltage sensing module 1036 compares the voltage at the positive output node VSPOS and the positive SEG voltage. If the difference is lower than a threshold, the voltage sensing module 1036 then determines that the voltage at the positive output node meets the design specification. Similarly, the voltage sensing module 1036 also determines whether the voltage at the negative output node VSNEG meets the design specification, by comparing the voltage at the negative output node VSNEG and the negative SEG voltage.

The control module 1030 may also include a logic controller 1032 (e.g., a processor or a logic control circuit). The logic controller 1032 may receive a signal DISCHARGE/CHARGE signal from the current sensing module 1034 indicating whether it should be a charge time or discharge time next. The signal may be, for example, a logic signal being either a logic 1 (or HIGH value) or a logic 0 (or LOW value). The two different logic values correspond to a charge time or a discharge time respectively.

The logic controller 1032 may also receive from the voltage sensing module 1036 a signal (VSPOS_OK) indicating whether the voltage at the positive output node meets the design specification and a signal (VSNEG_OK) indicating whether the voltage at the negative output node meets the design specification. Each of the VSPOS_OK signal and the VSNEG_OK signal may be a logic signal being either a logic 1 (or HIGH value) or a logic 0 (or LOW value).

The logic controller 1032 receives the signals from the current sensing module 1034 and the voltage sensing module 1036 and controls the operation of the power supply circuit 1010 based on these signals. The control logic circuit 1032 controls the operation by providing control signals for the switch S and the inverter 1022. In one implementation, the logic controller 1032 controls the power supply circuit 1010 by configuring the power supply circuit 1010 to be in one of four configurations at a time.

The logic controller 1032 may use a level shift module 1038 to generate a control signal for the switch S. The control signal may be a logic signal being either a logic 1 (or HIGH value) or a logic 0 (or LOW value). Depending on the value of the control signal, the switch S connects the first end 912 of the inductor L to, or disconnects it from, the voltage source VBAT.

The logic controller 1032 may use another level shift module 1042 to generate a control signal for the inverter 1022. The control signal may be a logic signal being either a logic 1 (or HIGH value) or a logic 0 (or LOW value). Depending on the value of the control signal, the inverter 1022 connects the second end 1014 of the inductor L to either a ground potential GND (when the control signal has a logic 1 or HIGH value) or the positive output node VSPOS (when the control signal has a logic 0 or LOW value.)

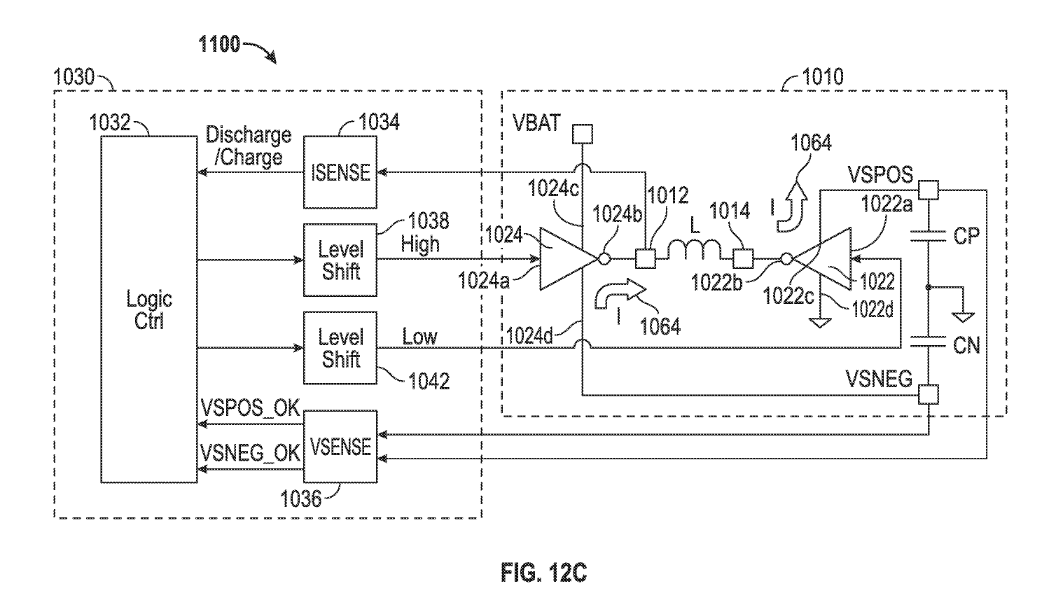

FIG. 11 shows another example of an apparatus for providing a negative output voltage and a positive output voltage using a single external inductor. Unlike the apparatus 1000 shown in FIG. 10, the apparatus 1100 shown in FIG. 11 is modified by replacing the external diode 1018 and the switch S (shown in FIG. 10) with an inverter 1024 which can be integrated. The inverter 1024 (shown in FIG. 11) can be similar to the inverter 1022 (shown in FIG. 10).

The inverter 1024 connects the first end 1012 of the inductor L to either the negative output node VSNEG or the voltage source VBAT. The inverter 1024 has a first terminal 1024c connected to the negative output node VSNEG and a second terminal 1024d connected to the voltage source VBAT. The inverter 1024 further includes an input terminal 1024a which receives a control signal from the control module 1030 and an output terminal 1024b connected to the first end 1012 of the inductor L.

The logic controller 1032 may use the level shift module 1038 to generate a control signal for the inverter 1024. The control signal may be a logic signal being either a logic 1 (or HIGH value) or a logic 0 (or LOW value). The inverter 1024 connects the first end 1012 of the inductor L to the negative output node VSNEG (when the control signal has a logic 1 or HIGH value), and to the voltage source VBAT (when the control signal has a logic 0 or LOW value).

The implementations 1000 and 1100 shown in FIGS. 10 and 11 may generate both the positive SEG voltage and the negative SEG voltage with only one external inductor. The positive SEG voltage and the negative SEG voltage are generated at the positive output node VSPOS and the negative output node VSNEG, respectively. In the absence of a load, such as a connection to a segment line of the display array, at the positive output node VSPOS, the positive output capacitor CP retains any present charge (except perhaps for small leakage currents) while the voltage at the positive output node VSPOS is substantially stable. If a load is present, charge will flow from the positive output capacitor CP through the load, thereby decreasing the amplitude of the voltage at the positive output node VSPOS. Once the amplitude of the voltage at the node VSPOS decreases below a predetermined threshold, the switch S and/or inverters (1022, 1024) of the power supply circuit 1010 (shown in FIGS. 10 and 11) may be controlled such that additional positive charge is pumped into the positive output capacitor CP.

Similarly, in the absence of a load at the negative output node VSNEG, the negative output capacitor CN retains any present charge and the voltage at the negative output node VSNEG is substantially stable. If a load is present, charge will flow to the negative output capacitor CN through the load, thereby decreasing the amplitude of the voltage at the negative output node VSNEG. Once the amplitude of the voltage decreases below a predetermined threshold, the switch S and/or inverters (1022, 1024) of the power supply circuit 1010 (shown in FIGS. 10 and 11) may be controlled such that additional positive charge is drained from the negative output capacitor CN.

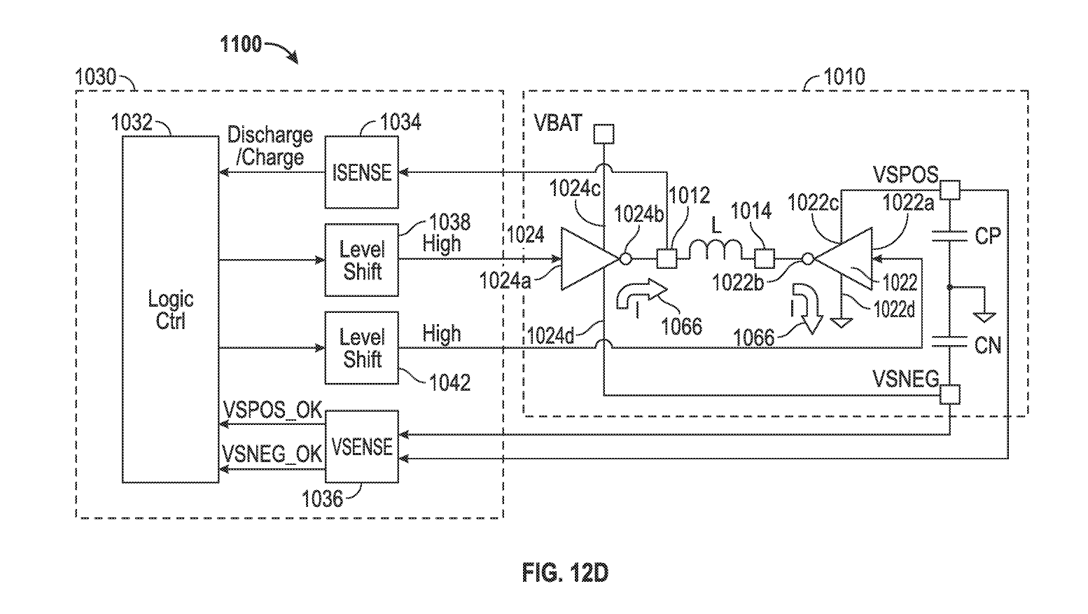

FIGS. 12A-12D illustrate an example of operational modes of the apparatus 1100 (shown in FIG. 11). Though FIGS. 12A-12D uses the power supply circuit in FIG. 11 for illustration, these operational modes (also referred to as “configurations”) are equally applicable to the power supply circuit in FIG. 10. In one implementation, there are four different operation modes. At any time, one of the operation modes may be selected based on the sensed current flowing through the inductor L and the voltages at the negative output node VSNEG and the positive output node VSPOS.

In one implementation, the control module 1030 determines whether the voltages at the positive output node VSPOS and the negative output node VSNEG meet the design specification based on signals from the voltage sensing module 1036. In one implementation, the voltage sensing module 1036 compares the voltage at the positive output node VSPOS and the positive voltage which the power supply circuit 1010 apparatus 1000 is configured to generate. If the difference is lower than a threshold, the voltage sensing module 1036 then determines that the voltage at the positive output node meets the design specification. Similarly, the voltage sensing module 1036 also determines whether the voltage at the negative output node VSNEG meets the design specification, by comparing the voltage at the negative output node VSNEG and the negative voltage which the power supply circuit 1010 is configured to generate.

FIG. 12A illustrates an example of a first operation mode of the power supply circuit 1010. The control module 1030 may configure the power supply circuit 1010 into the first mode, when determining it is time to charge the inductor L (DISCHARGE/CHARGE signal low) and sensing that the voltage at the negative output node VSNEG does not meet the design specification (VSNEG_OK low) (e.g., the voltage is substantially higher than the negative SEG voltage). In the first mode, the inverters (1022 and 1024) are controlled so that the voltage source VBAT is connected to the first end 1012 of the inductor L and the second end 1014 of the inductor L is connected to the ground potential. This causes a current to flow along a current path 1060 from the voltage source VBAT through the inductor L to the ground potential thus storing energy in the inductor L.

FIG. 12B illustrates an example of a second operation mode of the power supply circuit 1010. The control module 1030 may configure the power supply circuit 1010 into the second mode, when determining it is time to charge the inductor L (DISCHARGE/CHARGE signal low) and sensing that the voltage at the negative output node VSNEG meets the design specification (VSNEG_OK high) but the voltage at the positive output node VSPOS does not meet the design specification (VSPOS_OK low) (e.g., the voltage is substantially lower than the positive SEG voltage). In the second mode, the inverters (1022 and 1024) are controlled so that the voltage source VBAT is connected to the first end 1012 of the inductor L and the second end 1014 of the inductor L is connected to the positive output node VSPOS. This causes a current to flow along a current path 1062 from the voltage source VBAT through the inductor L to the positive output node VSPOS. Thus, energy is transferred from the voltage source VBAT and stored in the inductor L. In addition, positive charge is pumped into the positive output capacitor CP thus increasing the positive voltage at the positive output node VSPOS.

FIG. 12C illustrates an example of a third operation mode of the power supply circuit 1010. The control module 1030 may configure the power supply circuit 1010 into the third mode, when determining it is time to discharge the inductor L (DISCHARGE/CHARGE signal high) and sensing that neither of the voltages at the negative output node VSNEG and the positive output node VSPOS meets the design specification (VSNEG_OK low and VSPOS_OK low). In the third mode, the inverters (1022 and 1024) are controlled so that the negative output node VSNEG is connected to the first end 1012 of the inductor L and the second end 1014 of the inductor L is connected to the positive output node VSPOS. This causes a current to flow along a current path 1064 from the negative output node VSNEG through the inductor L to the positive output node VSPOS. So positive charge is pumped into the positive output capacitor CP thus increasing the voltage at the positive output node VSPOS, and negative charge is pumped into the negative output capacitor CN thus increasing the amplitude of the negative voltage at the negative output node VSNEG.

FIG. 12D illustrates an example of a fourth operation mode of the power supply circuit 1010. The control module 1030 may configure the power supply circuit 1010 into the fourth mode, when determining it is time to discharge the inductor L (DISCHARGE/CHARGE signal high) and sensing that the voltage at the positive output node VSPOS meets the design specification (VSPOS_OK high), but the voltage at the negative output node VSNEG does not meet the design specification (VSNEG_OK low). In the fourth mode, the inverters (1022 and 1024) are controlled so that the negative output node VSNEG is connected to the first end 1012 of the inductor L and the second end 1014 of the inductor L is connected to the ground potential. This causes a current to flow along a current path 1066 from the negative output node VSNEG through the inductor L to the ground potential. Negative charge is pumped into the negative output capacitor CN thus decreasing the voltage at the negative output node VSNEG (which increases the amplitude of the negative voltage).

To a certain extent, the implementations of power circuits depicted in FIGS. 12B-12D can support asymmetric current load. For example, the power circuit illustrated in FIG. 12B can have a negative output current load less than a positive output current load during charging cycle. As another example, the power circuit illustrated in FIG. 12C can have a negative output current load less than a positive output current load during discharging cycle. Since, the discharge current path is between the negative output current load side and ground as shown by current path 1066 in FIG. 12D, the positive output current load can much less than the negative output current load during charging and/or discharging cycles.

When the power circuits illustrated in FIGS. 11 and 12A-D are used to supply power to an array of display elements, such as interferometric modulators, SEG boosters current loads come from charging the panel capacitor with SEG positive output side and discharge the panel capacitance with negative output side. In such implementations, the average current load as seen on booster capacitor outputs CP and CN are about the same. Although, the panel capacitor is not shown in FIGS. 11 and 12A-12D, the panel capacitor connects alternatively to VSPOS and VSNEG through a control driver switch. The capacitors CP and CN illustrated in FIGS. 10, 11 and 12A-12D are storage capacitors configured to supply instant peak current to the panel capacitor.

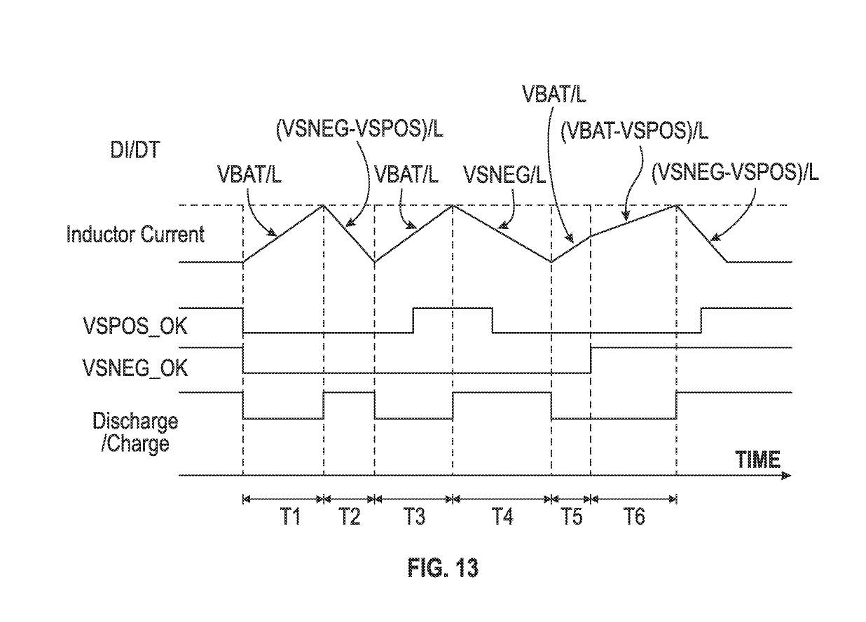

FIG. 13 illustrates the inductor current, the VSPOS_OK signal, the VSNEG_OK signal, and the DISCHARGE/CHARGE signal of the apparatus 1100 (shown in FIG. 11) versus time in an example of operations. In this example, the apparatus 1100 (shown in FIG. 11) is either in a discharge cycle in which energy is stored in the inductor L or a charge cycle in which energy stored in the inductor L is transferred to at least one of the negative output node VSNEG or the positive output node VSPOS.

At the start of a time period T1, the inductor current is at a bottom level (e.g., substantially close to zero) so it is determined to next charge the inductor L (DISCHARGE/CHARGE signal low). None of the voltages at the positive output node VSPOS and the negative output node VSNEG meets the design specification (VSPOS_OK low and VSNEG_OK low). As a result, the apparatus 1000 is configured to operate in the first operation mode (shown in FIG. 12A). In the first operation mode, energy is transferred from the voltage source VBAT and stored in the inductor L. The inductor current thus changes at a rate of VBAT/L, wherein VBAT is the voltage of the voltage source VBAT and L is the inductance of the inductor L.

At the start of a time period T2, the inductor current reaches its peak level so it is determined to next discharge the inductor L (DISCHARGE/CHARGE signal high). None of the voltages at the positive output node VSPOS and the negative output node VSNEG meets the design specification (VSPOS_OK low and VSNEG_OK low). As a result, the apparatus 1000 is configured to operate in the third operation mode (shown in FIG. 12C). In the third operation mode, energy stored in the inductor L is transferred to the negative output capacitor CN and the positive output capacitor CP. So positive charge is pumped into the positive output capacitor CP thus increasing the voltage at the positive output node VSPOS, and negative charge is pumped into the negative output capacitor CN thus decreasing the voltage at the negative output node VSNEG. The inductor current changes at a rate of (VSNEG-VSPOS)/L, wherein VSNEG, VSPOS, and L are the voltage at the negative output node VSNEG, the voltage at the positive output node VSPOS and the inductance of the inductor L respectively.

At the start of a time period T3, the inductor current is decreased to the bottom level so it is determined to next charge the inductor L (DISCHARGE/CHARGE signal low). None of the voltages at the positive output node VSPOS and the negative output node VSNEG meets the design specification (VSPOS_OK low and VSNEG_OK low). As a result, the apparatus 1000 is configured to operate in the first operation mode (shown in FIG. 12A). The inductor current thus increases.

At the start of a time period T4, the inductor current reaches its peak level so it is determined to next discharge the inductor L (DISCHARGE/CHARGE signal high). The voltage at the positive output node VSPOS meets the design specification but the negative output node VSNEG does not meet the design specification (VSPOS_OK high and VSNEG_OK low). As a result, the apparatus 1100 is configured to operate in the fourth operation mode (shown in FIG. 12D). In the fourth operation mode, energy stored in the inductor L is transferred to the negative output capacitor CN. Negative charge is pumped into the negative output capacitor CN thus decreasing the voltage at the negative output node VSNEG. The inductor current thus changes at a rate of VSNEG/L, wherein VSNEG is the voltage at the negative output node VSNEG and L is the inductance of the inductor L.

At the start of a time period T5, the inductor current reaches its bottom level so it is determined to next charge the inductor L (DISCHARGE/CHARGE signal low). None of the voltages at the positive output node VSPOS and the negative output node VSNEG meets the design specification (VSPOS_OK low and VSNEG_OK low). As a result, the apparatus 1100 is configured to operate in the first operation mode (shown in FIG. 12A). In the first operation mode, energy is transferred from the voltage source VBAT and stored in the inductor L. The inductor current thus increases.

At the start of a time period T6, the inductor current has not reached its peak value so it is determined to continue to charge the inductor L (DISCHARGE/CHARGE signal low). The voltage at the negative output node VSNEG meets the design specification but the positive output node VSPOS does not meet the design specification (VSPOS_OK low and VSNEG_OK high). As a result, the apparatus 1100 is configured to operate in the second operation mode (shown in FIG. 12B). In the second operation mode, energy is transferred from the voltage source VBAT and stored in the inductor L. In addition, positive charge is pumped into the positive output capacitor CP thus increasing the positive voltage at the positive output node VSPOS. The inductor current thus changes at a rate of (VBAT-VSPOS)/L, wherein VBAT is the voltage of the voltage source VBAT, VSPOS is the voltage at the positive output node VSPOS, and L is the inductance of the inductor L.

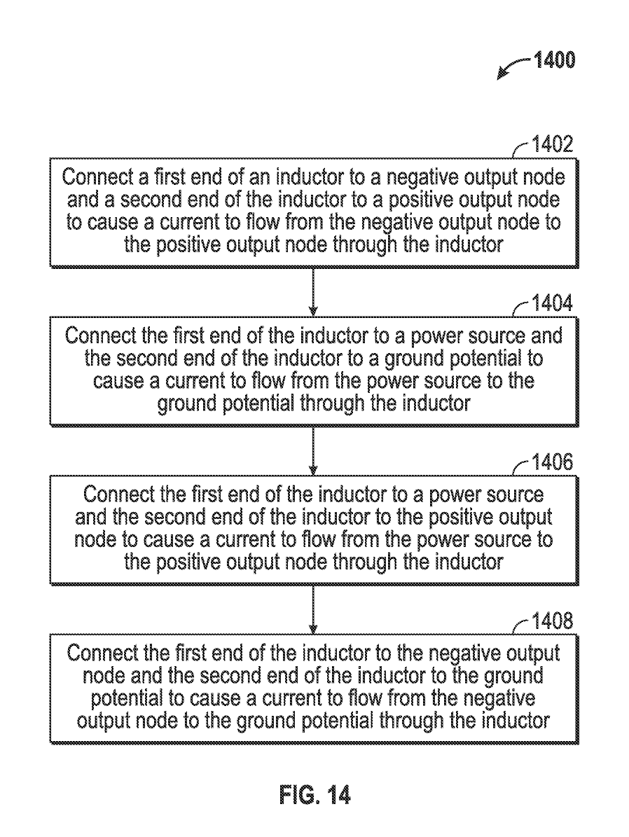

FIG. 14 shows an example of a flow diagram illustrating a method 1400 for providing negative and positive output voltages using a single inductor. The method 1400 may be, for example, performed by the logic controller 1032 of the apparatus 1000 (shown in FIGS. 10 and 11) by configuring the switch S and inverter 1022 (in FIG. 10) or the inverters 1022 and 1024 (in FIG. 11) of the power supply circuit 1010 into different operation modes (as shown in FIGS. 12A-D). The negative output voltage and the positive output voltage may be the negative SEG voltage and the positive SEG voltage as described above respectively. Depending on the implementation, certain blocks of the method may be removed. In addition, the blocks of the method do not have to be performed in a particular order.

At block 1402, the method 1400 includes connecting a first end of an inductor to a negative output node and a second end of the inductor to a positive output node to cause a current to flow from the negative output node to the positive output node through the inductor, wherein the negative output node is configured to generate a negative output voltage and the positive output node is configured to generate a positive output voltage. Block 1402 may be performed when the logic controller 1032 (shown in FIGS. 10 and 11) configures the power supply circuit 1010 (shown in FIGS. 10 and 11) into the third operation mode (shown in FIG. 12C). In one implementation, Block 1402 is performed when the inductor is being discharged in a discharge time and neither of the voltages at the positive output node VSPOS and the negative output node VSNEG meets the design specification. In one implementation, the voltage at the positive output node VSPOS does not meet the design specification when being substantially different from the positive output voltage, and the voltage at the negative output node VSNEG does not meet the design specification when being substantially different from the negative output voltage.

At block 1404, the method 1400 includes connecting the first end of the inductor to a power source and the second end of the inductor to a ground potential to cause a current to flow from the power source to the ground potential through the inductor. Block 1404 may be performed when the logic controller 1032 (shown in FIGS. 10 and 11) configures the power supply circuit 1010 (shown in FIGS. 10 and 11) into the first operation mode (shown in FIG. 12A). In one implementation, Block 1404 is performed when the inductor is being charged in a charge time and the voltage at the negative output node does not meet the design specification.

At block 1406, the method 1400 includes connecting the first end of the inductor to the power source and the second end of the inductor to the positive output node to cause a current to flow from the power source to the positive output node through the inductor. Block 1406 may be performed when the logic controller 1032 (shown in FIGS. 10 and 11) configures the power supply circuit 1010 (shown in FIGS. 10 and 11) into the second operation mode (shown in FIG. 12B). In one implementation, Block 1406 is performed when the inductor is being charged in a charge time and the voltage at the negative output node VSNEG meets the design specification but the voltage at the positive output node VSPOS does not meet the design specification.

At block 1408, the method 1400 includes connecting the first end of the inductor to the negative output node and the second end of the inductor to the ground potential to cause a current to flow from the negative output node to the ground potential through the inductor. Block 1408 may be performed when the logic controller 1032 (shown in FIGS. 10 and 11) configures the power supply circuit 1010 (shown in FIGS. 10 and 11) into the fourth operation mode (shown in FIG. 12D). In one implementation, Block 1408 is performed when the inductor is being discharged in a discharge time and the voltage at the positive output node VSPOS meets the design specification but the voltage at the negative output node does not meet the design specification.

In one implementation, the apparatus 1000 and 1100 (shown in FIGS. 10 and 11 respectively) allows to generate both the positive SEG voltage and the negative SEG voltage with only one external inductor. Also, the apparatus 1000 replaces one or more of external Schottky diodes with a switch which can be integrated. The overall power efficiency is increased compared to the converters (shown in FIGS. 9A and 9B) with two separate inductors. The power efficiency improvement may be even more evident when the average current output loads generated by positive SEG voltage and the negative SEG voltage are quasi-symmetric (having approximately the same amplitude but opposite polarities). The apparatus 1000 and 1100 allows the inductor L to transfer positive charge away from the negative output node VSNEG to the positive output node VSPOS during a discharge time. The discharge time and the relative power loss in the diode 926 of the negative converter (shown in FIG. 9B) are reduced by about 50%.

Table I as shown below includes simulation results comparing power efficiency of these devices. As shown in Table I, the combined power efficiency from a single output Buck converter (shown in FIG. 9A) and a single output negative Flyback converter (shown in FIG. 9B) is 76%. Under similar conditions, the power efficiency of the apparatus 1000 (shown in FIG. 10) is 85%. This corresponds to a 9% overall power efficiency improvement.

TABLE I
Simulation Result

| | Input | Input | Output | | |
|---|---|---|---|---|---|
| | Current | Voltage | Current Load | Output | Power |
| DC to DC Converter Type | (mA) | (V) | (mA) | Voltage (V) | efficiency (%) |
| BUCK (single output) | 70 | 3.3 | 100 | 2 | 86 |
| Negative FLYBACK (single output) | 90 | 3.3 | −100 | −2 | 67 |
| IDF (single inductor dual output) | 142 | 3.3 | +/−100 | +/−2 | 85 |

In the foregoing implementations, an apparatus for generating a negative SEG voltage and a positive SEG voltage using a single inductor is described, wherein the negative SEG voltage and the positive SEG voltage are used to drive the SEG lines of a display array such as one based on microelectromechanical devices. However, the apparatus described herein does not have to be limited to generating the SEG voltages for a display, or even any voltages for a display. The apparatus may be equally used to generate a set of a positive output voltage and a negative output voltage for other applications.

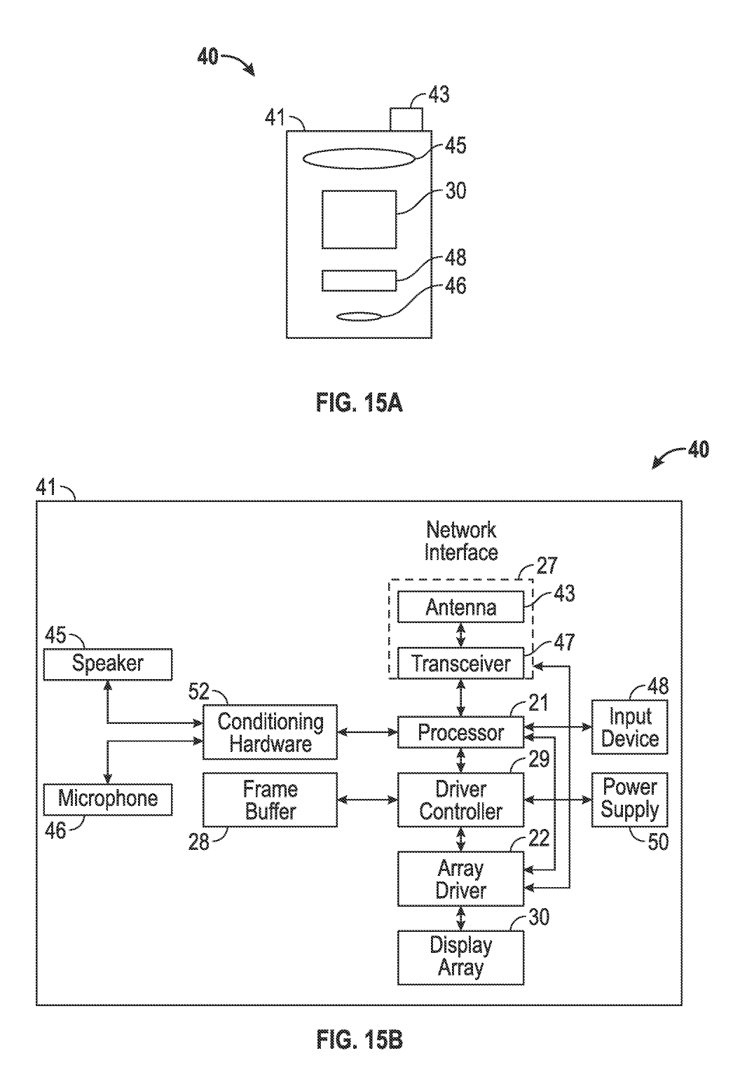

FIGS. 15A and 15B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 15B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A power supply capable of providing a negative output voltage and a positive output voltage, the power supply comprising:
a power source;
an inductor having a first end and a second end, the first end coupled to at least a first switch and being configured to connect to either the power source or a negative output node depending on the state of the first switch, the second end coupled to at least a second switch and being configured to connect to either a ground potential or a positive output node depending on the state of the second switch, the negative output node being configured to generate the negative output voltage, the positive output node being configured to generate the positive output voltage; and
a controller adapted to configure the first and second switches into at least:
a first configuration in which the first end of the inductor is connected to the negative output node while the second end of the inductor is connected to the positive output node, causing a current to flow from the negative output node to the positive output node through the inductor;
a second configuration in which the first end of the inductor is connected to the power source while the second end of the inductor is connected to the ground potential, causing a current to flow from the power source to the ground potential through the inductor;
a third configuration in which the first end of the inductor is connected to the power source while the second end of the inductor is connected to the positive output node, causing a current to flow from the power source to the positive output node through the inductor; and
a fourth configuration in which the first end of the inductor is connected to the negative output node while the second end of the inductor is connected to the ground potential, causing a current to flow from the negative output node to the ground potential through the inductor.

2. The power supply of claim 1, wherein the controller configures the first and second switches into the first configuration when the inductor is being discharged and the voltages at the positive output node and the negative output node are substantially different from the positive output voltage and the negative output voltage respectively.

3. The power supply of claim 1, wherein the negative output voltage and the positive output voltage have approximately the same amplitude and opposite polarities.

4. The power supply of claim 1, wherein the amplitude of the negative output voltage is between about 80% and 120% of the amplitude of the positive output voltage.

5. The power supply of claim 1, further comprising:
a current sensing module configured to determine current flowing through the inductor; and
a voltage sensing module configured to monitor voltages at the positive output node and the negative output node,
wherein the controller is configured to configure the first and the second switches based on the current flowing through the inductor and the voltages at the positive output node and the negative output node.

6. The power supply of claim 1, wherein the second switch is an inverter configured to connect the second end of the inductor to either the ground potential or the positive output node depending on a first control signal from the controller, and the first switch is an inverter configured to connect the first end of the inductor to either the power source or the negative output node depending on a second control signal from the controller.

7. The power supply of claim 1, wherein the second switch is an inverter configured to connect the second end of the inductor to either the ground potential or the positive output node depending on a first control signal from the controller, and the first switch is configured to connect or disconnect the power source from the first end of the inductor depending on a second control signal from the controller, wherein the power supply further includes a diode configured to allow current to flow from the negative output node to the first end of the inductor.

8. The power supply of claim 1, further comprising a first capacitor having a first end coupled to the positive output node and a second end coupled to the ground potential, and a second capacitor having a first end coupled to the negative output node and a second end coupled to the ground potential.

9. A display device comprising:
the power supply of claim 1;
a plurality of display elements; and
a driver circuit configured to drive the display elements with a plurality of voltages including the negative output voltage and the positive output voltage from the power supply.

10. The display device of claim 9, further comprising:
a display;
a processor that is configured to communicate with the display, the processor being configured to process image data; and
a memory device that is configured to communicate with the processor.

11. The display device as recited in claim 10, further comprising:
a driver circuit configured to send at least one signal to the display.

12. The display device as recited in claim 11, further comprising:
a second controller configured to send at least a portion of the image data to the driver circuit.

13. The display device as recited in claim 9, further comprising:
an image source module configured to send the image data to the processor.

14. The display device as recited in claim 13, wherein the image source module includes at least one of a receiver, transceiver, and transmitter.

15. The display device as recited in claim 9, further comprising:
an input device configured to receive input data and to communicate the input data to the processor.

16. A method of generating a negative output voltage and a positive output voltage, the method comprising:
(a) connecting a first end of an inductor to a negative output node and a second end of the inductor to a positive output node to cause a current to flow from the negative output node to the positive output node through the inductor, wherein the negative output node is configured to generate a negative output voltage and the positive output node is configured to generate a positive output voltage;
(b) connecting the first end of the inductor to a power source and the second end of the inductor to a ground potential to cause a current to flow from the power source to the ground potential through the inductor;
(c) connecting the first end of the inductor to the power source and the second end of the inductor to the positive output node to cause a current to flow from the power source to the positive output node through the inductor; and
(d) connecting the first end of the inductor to the negative output node and the second end of the inductor to the ground potential to cause a current to flow from the negative output node to the ground potential through the inductor.

17. The method of claim 16, wherein the process (a) is performed when the inductor is being discharged and the voltages at the positive output node and the negative output node are substantially different from the positive output voltage and the negative output voltage respectively.

18. The method of claim 16, wherein the negative output voltage and the positive output voltage have approximately the same amplitude and opposite polarities.

19. The method of claim 16, wherein the amplitude of the negative output voltage is between about 80% and 120% of the amplitude of the positive output voltage.

20. The method of claim 16, further comprising:
determining current flowing through the inductor;
monitoring voltages at the positive output node and the negative output node; and
selecting one of the processes (a)-(d) to perform based on the current flowing through the inductor and the voltages at the positive output node and the negative output node.

21. An apparatus for providing a negative output voltage and a positive output voltage, the apparatus comprising:
a single power source;
a single inductor having a first end and a second end;
means for connecting the first end of the inductor to either the power source or a negative output node depending on a first control signal;
means for connecting the second end of the inductor to either a ground potential or a positive output node depending on a second control signal, the negative output node being configured to generate a negative output voltage, the positive output node being configured to generate a positive output voltage; and
means for generating the first and second control signals to configure the first end connecting means and the second end connecting means into at least
a first configuration in which the first end of the inductor is connected to the negative output node while the second end of the inductor is connected to the positive output node, causing a current to flow from the negative output node to the positive output node through the inductor;
a second configuration in which the first end of the inductor is connected to the power source while the second end of the inductor is connected to the ground potential, causing a current to flow from the power source to the ground potential through the inductor;
a third configuration in which the first end of the inductor is connected to the power source while the second end of the inductor is connected to the positive output node, causing a current to flow from the power source to the positive output node through the inductor; and
a fourth configuration in which the first end of the inductor is connected to the negative output node while the second end of the inductor is connected to the ground potential, causing a current to flow from the negative output node to the ground potential through the inductor.

22. The apparatus of claim 21, wherein the means for connecting the second end includes an inverter configured to connect the second end of the inductor to either the ground potential or the positive output node depending on the first control signal, and the means for connecting the first end includes an inverter configured to connect the first end of the inductor to either the power source or the negative output node depending on the second control signal.

23. The apparatus of claim 21, wherein the means for connecting the second end includes an inverter configured to connect the second end of the inductor to either the ground potential or the positive output node depending on the first control signal, and the means for connecting the first end includes a switch configured to connect or disconnect the power source from the first end of the inductor depending on the second control signal, wherein the apparatus further includes a diode configured to allow current to flow from the negative output node to the first end of the inductor.

24. The apparatus of claim 21, wherein the means for generating control signals includes a controller.

25. The apparatus of claim 21, wherein the negative output voltage and the positive output voltage have approximately the same amplitude and opposite polarities.

26. The apparatus of claim 21, wherein the amplitude of the negative output voltage is between about 80% and 120% of the amplitude of the positive output voltage.
